(19) United States
(12) Patent Application Publication
(10) Pub. No.: US 2009/0046191 A1
(43) Pub. Date: Feb. 19, 2009

(54) IMAGE PICKUP DEVICE

(76) Inventors: Yukihiro IWATA, Osaka (JP); Masato Tobinaga, Hyogo (JP); Shinya Ogasawara, Hyogo (JP); Miyoko Irikiin, Hyogo (JP)

Correspondence Address: WENDEROTH, LIND & PONACK L.L.P., 2033 K. STREET, NW, SUITE 800, WASHINGTON, DC, 20006, US

(21) Appl. No.: 12/190,769

(22) Filed: Aug. 13, 2008

(30) Foreign Application Priority Data
Aug. 15, 2007 (JP) 2007-211702

(51) Int. Cl. H04N 5/335

(52) U.S. Cl. 348/311; 348/E05.091

(57) ABSTRACT

The image pickup device includes a color separation prism, solid-state image sensors, a light shielding layer and a heat radiating layer. The color separation prism, made up of a plurality of prism members, separates light incident thereon through an image pickup lens into a plurality of color components. The plurality of solid-state image sensors are fixed to the plurality of prism members, respectively. The light shielding layer is placed so as to cover surfaces of the color separation prism. The heat radiating layer, formed from a high heat conductivity material, is placed on a surface of the light shielding layer so as to be kept from contact with each of the solid-state image sensors. Thus, in the image pickup device, temperature increases of the solid-state image sensors are suppressed while external-force loads applied to the solid-state image sensors are reduced, with a relatively simple structure.

### BACKGROUND OF THE INVENTION

1. Field of the Invention

The present invention relates to image pickup devices, such as television cameras and video cameras, equipped with solid-state image sensors.

2. Description of Related Art

In recent years, there have been developed, and now in widespread use, 3CCD color cameras (hereinafter, referred to as 3CCD cameras) as an image pickup device using three solid-state image sensors. The structure of such a conventional 3CCD camera is explained below with reference to the accompanying drawings.

FIG. 1 is a schematic sectional view of an image pickup block 10 in a conventional 3CCD camera. As shown in FIG. 1, the image pickup block 10 includes a color separation prism for separating incident light, which has come up through an unshown image pickup lens of the 3CCD camera, into specified color components, a plurality of solid-state image sensors, and image sensor boards on which the solid-state image sensors are mounted, respectively.

As shown in FIG. 1, the color separation prism is made up of three prism members 1r, 1g, 1b, which are bonded together in close contact with one another. The color separation prism constructed like this is a three color separation prism 1 for separating incident light into three color components. Bonded interfaces on the prism members 1r, 1g, 1b serve as dichroic mirrors 4, 5. On light-outgoing surfaces of the three prism members 1r, 1g, 1b, solid-state image sensors 2r, 2g, 2b are fixed individually with adhesive.

Referring to FIG. 1, a light beam 7 incident on the three color separation prism 1 is separated by the dichroic mirrors 4, 5 into three color components, i.e. light beams 6a, 6b, 6c of three primary colors of light, and the resultant light beams are received by their corresponding solid-state image sensors 2r, 2g, 2b, respectively. Out of the light beams separated into the three primary colors and reflected by the dichroic mirrors 4, 5, the light beams 6a, 6b are totally reflected again within the prism members 1g, 1b, respectively, thereby being received by the solid-state image sensors 2g, 2b as light beams that form not a mirror image (reflected image) but a non-mirror image. Image pickup signal processing against the individual light beams received by the solid-state image sensors 2g, 2b, 2r, respectively, is performed by the image sensor boards 3r, 3g, 3b, respectively, so that a color television signal in which the image pickup signals are composited is obtained.

For the conventional 3CCD camera having such a structure described above, there is a need for achieving high-accuracy superimposition of three-color subject images. Poor accuracy of superimposition, i.e. poor accuracy of registration, would lead to occurrence of color differences or moire false signals, resulting in a subtly deteriorated image. Accordingly, in order to prevent any deterioration of registration accuracy, there is a need for reducing external-force loads applied to the respective solid-state image sensors 2r, 2g, 2b.

Further, if used under a high-temperature environment, a solid-state image sensor would incur image quality deterioration due to white scratches, life reduction and so on, and therefore needs to be used at a specified temperature or lower. Particularly in recent years, in image pickup devices typified by 3CCD cameras on which solid-state image sensors are mounted, there is a tendency that the ambient temperature of the solid-state image sensors (i.e., internal temperature within the device casing) increases more and more with increasing power consumption that can be attributed to light, thin, short and small dimensions and more multiple and higher functions of the device, making it indispensable to provide a means for cooling the solid-state image sensors.

Therefore, in conventional image pickup devices, there have been proposed various heat radiating structures for efficiently cooling solid-state image sensors while reducing the external loads applied to the solid-state image sensors (see, e.g., Document 1: JP H1-295575 A, Document 2: JP 2002-247594 A, and Document 3: JP 2001-308569 A).

First, Document 1 proposes a heat radiating structure in which a thermoelectric cooling device mounted on a heat transfer member by screw is placed so as to be in contact with the back face of each solid-state image sensor. In such a heat radiating structure, since deformations due to thermal expansion and thermal contraction of each member can be absorbed by backlashes of the screws, forces due to the thermal deformations can be prevented from being applied from the cooling device to the solid-state image sensor.

Also, Document 2 proposes a heat radiating structure in which a thermoelectric cooling device fixed to a heat conducting plate is so placed as to be put into close contact with the back faces of the solid-state image sensors with proper force by utilizing the elasticity of the heat conducting plate. In such a heat radiating structure, since the cooling device can be put into close contact with the back faces of the solid-state image sensors by utilizing the elasticity of the heat conducting plate, there can be realized an efficient heat radiation.

Document 3 proposes a heat radiating structure using no thermoelectric cooling device in which a metallic component is inserted between the back face of a solid-state image sensor and the image sensor board so as to allow heat to escape from the solid-state image sensor through the metallic component.

### SUMMARY OF THE INVENTION

In recent years, the positioning of individual solid-state image sensors in such a 3CCD camera has been under a demand for accuracy on the order of μm. For example, the positioning of the individual solid-state image sensors 2r, 2g, 2b, as it stands, has been coming to require accuracies on the order of several tens of μm for the positioning in the optical axis direction because of a depth of focus, and the order of μm for that of the in-plane direction of the subject image.

However, in the heat radiating structure of Document 1, since external forces are absorbed by the backlashes of the screws, external forces caused by small thermal deformations cannot be absorbed enough. Therefore, depending on the magnitude of an external force that acts on the solid-state image sensors, the external force may affect the positioning accuracy of those image sensors, giving rise to an issue of deterioration of registration accuracy due to positional shifts. Also, in the heat radiating structure of Document 2, since external forces are applied to the solid-state image sensors by elasticity of the heat conducting plate and the external forces vary depending on thermal expansion or the like, there are cases where the positioning accuracy is affected by the external forces. Furthermore, in the heat radiating structures of Documents 1 and 2, since relatively expensive thermoelectric cooling devices are used, the cost of the image pickup device goes up.

Even in the heat radiating structure of Document 3 using no cooling devices, since the metallic component is placed so as to be in contact with the back faces of the solid-state image sensors, a load due to springback caused by thermal expansion and contraction of the metallic member is applied to the solid-state image sensors. This results in occurrence of positional shifts at bonding surfaces between the solid-state image sensors and the prism member, giving rise to an issue of deterioration of registration accuracy due to the positional shifts. Furthermore, any one of the heat radiating structures of Documents 1 to 3 is complicated in structure, being no simple to attach or handle.

Moreover, there has been widely used a technique of fixing bonding surfaces of the solid-state image sensors 2r, 2g, 2b, in which, with the use of UV adhesive (ultraviolet curable adhesive) for the bonding between front faces of the solid-state image sensors 2r, 2g, 2b and the prisms 1r, 1g, 1b, the solid-state image sensors 2r, 2g, 2b are position controlled (for six axes) after the adhesive is applied to between their bonding surfaces, and ultraviolet radiation is applied thereto to cure the adhesive.

However, since such UV adhesive has a high temperature creep property (a property of creeping due to continued application of a load under a high temperature environment), the load due to the springback of the metallic component or the like becomes a serious matter particularly as the ambient temperature of the solid-state image sensors 2r, 2g, 2b (i.e., internal temperature within the device casing) becomes higher.

Accordingly, an object of the present invention, lying in solving the above-described issues, is to provide an image pickup device including solid-state image sensors which device is capable of suppressing temperature increases of its solid-state image sensors while reducing external-force loads applied to the solid-state image sensors with a simple structure.

In order to achieve the above object, the present invention has the following constitutions.

According to a first aspect of the present invention, there is provided an image pickup device comprising:

a color separation prism made up of a plurality of prism members, for separating light incident thereon through an image pickup lens into a plurality of color components;

a plurality of solid-state image sensors fixed to the plurality of prism members, respectively;

a light shielding layer placed so as to cover a surface of the color separation prism; and

a heat radiating layer which is formed from a high heat conductivity material placed on a surface of the light shielding layer so as to be kept from contact with each of the solid-state image sensors.

According to a second aspect of the present invention, there is provided the image pickup device as defined in the first aspect, wherein in side faces of the prism members adjoining joint surfaces onto each of which the solid-state image sensor is fixed, the heat radiating layer is placed at least at ends of the side faces via the light shielding layer, the ends adjoining to the joint surfaces.

According to a third aspect of the present invention, there is provided the image pickup device as defined in the second aspect, wherein the light shielding layer is placed so as to cover surfaces of the color separation prism except an incidence surface for light derived from the image pickup lens and except the joint surfaces of the prism members, and the heat radiating layer is placed so as to cover the light shielding layer.

According to a fourth aspect of the present invention, there is provided the image pickup device as defined in the first aspect, wherein a heat shielding layer for suppressing penetration of heat radiated from outside of the color separation prism into inside thereof is placed on a surface of the heat radiating layer.

According to a fifth aspect of the present invention, there is provided the image pickup device as defined in the fourth aspect, wherein the heat shielding layer is a heat insulating layer for intercepting the radiated heat.

According to a sixth aspect of the present invention, there is provided the image pickup device as defined in the fourth aspect, wherein the heat shielding layer is a reflecting layer for reflecting the radiated heat.

According to a seventh aspect of the present invention, there is provided the image pickup device as defined in the first aspect, wherein the heat radiating layer is connected to a body casing of the image pickup device.

According to the present invention, by virtue of its adopting a structure that a heat radiating layer is placed further on a surface of a light shielding layer which is so placed as to cover surfaces of a color separation prism to which solid-state image sensors are fixed, heat generated in the individual solid-state image sensors can be transferred to the heat radiating layer via the color separation prism and the light shielding layer so as to be radiated. Moreover, since the heat radiating layer is so placed as not to be in contact with the solid-state image sensors, there is no occurrence of stress loads such as springback from the heat radiating layer to the solid-state image sensors. Thus, with a relatively simple structure, occurrence of stress loads from the heat radiating layer to the solid-state image sensors can be prevented while necessary heat radiation performance is ensured, so that the image pickup device can be prevented from deterioration of registration accuracy.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a schematic view of an image pickup block in a conventional 3CCD color camera;

FIG. 2 is a schematic perspective view of an image pickup block which has not yet equipped with a heat radiating structure for solid-state image sensors according to an embodiment of the invention;

FIG. 3 is a schematic view of the image pickup device of the embodiment;

FIG. 4 is a schematic perspective view of a state in which the image pickup block of FIG. 2 is equipped with the heat radiating structure of the embodiment;

FIG. 5 is a schematic sectional view for explaining the structure of the light shielding member of the embodiment;

FIG. 6 is another schematic sectional view for explaining the structure of the light shielding member of the embodiment;

FIG. 7 is another schematic sectional view for explaining the structure of the light shielding member of the embodiment; and

FIG. 8 is a schematic view of a state in which the image pickup device of FIG. 3 is equipped with the heat radiating structure of the embodiment.

### DETAILED DESCRIPTION OF THE PREFERRED EMBODIMENTS

Before the description of the present invention proceeds, it is to be noted that like parts are designated by like reference numerals throughout the accompanying drawings.

Hereinbelow, an embodiment according to the present invention will be described in detail with reference to the accompanying drawings.

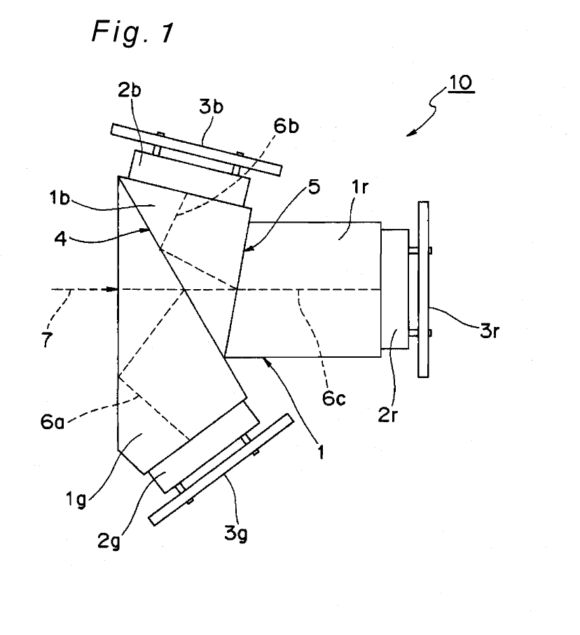

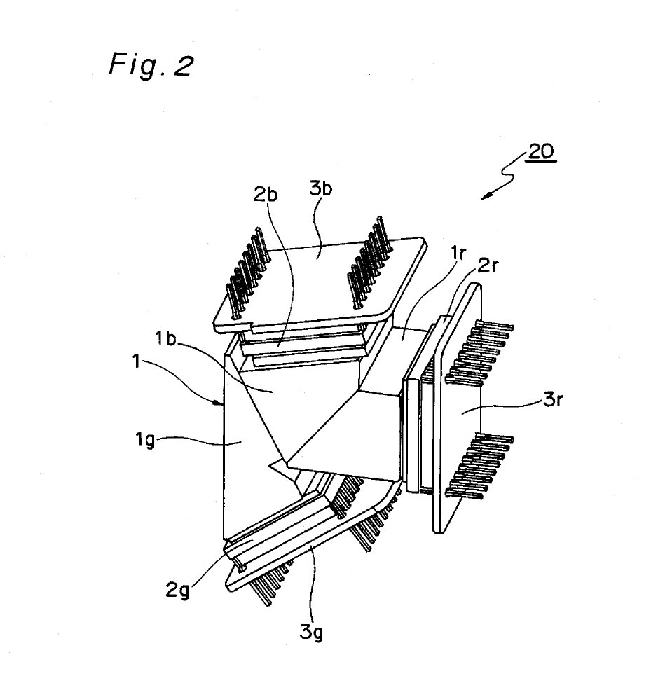

FIG. 2 shows a schematic perspective view of an image pickup block 20 (with the heat radiating structure not mounted) in a 3CCD camera as an example of the image pickup device equipped with a solid-state image pickup device in which solid-state image sensors and a prism are bonded together according to this embodiment. As shown in FIG. 2, the image pickup block 20 of this embodiment is so structured that individual solid-state image sensors 2r, 2g, 2b are bonded via adhesive to a three color separation prism 1 made up of three prism members 1r, 1g, 1b bonded via adhesive to one another. It is noted that the image pickup block 20 is similar in structure to the image pickup block 10 of FIG. 1, and so like component members are designated by like reference numerals and their description is omitted.

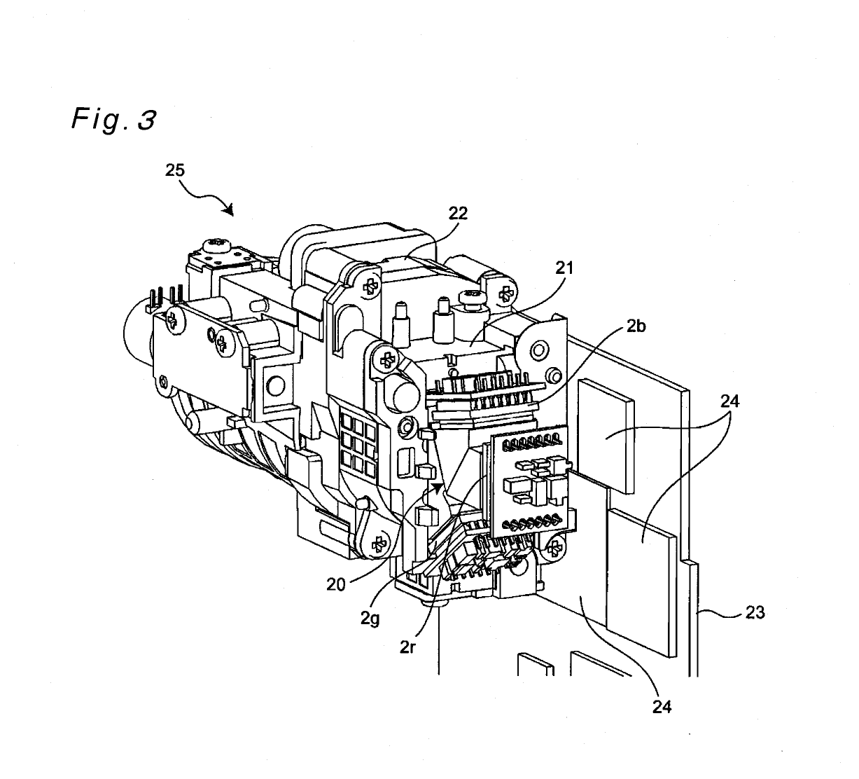

FIG. 3 shows a schematic perspective view of an image pickup device (camera) 25 equipped with the image pickup block 20 having such a structure as shown in FIG. 2. As shown in FIG. 3, the image pickup device 25 includes the image pickup block 20, a prism base 21 being a structure to which the image pickup block 20 is fixed and held, and a lens barrel 22 to which the prism base 21 is fixed and held so that an image-pickup optical axis is placed inside the prism base 21 so as to coincide with an optical axis of the image pickup block 20. Further, on the right hand of the image pickup block 20 as viewed in the figure, a plurality of IC chips 24 mounted on a board 23 are placed. These IC chips 24, which are made up by including image processing circuits for processing image information acquired by the solid-state image sensors, involves generation of heat in the processing of image information or the like, thus becoming heat generators in the image pickup device 25. Among such IC chips 24 that become heat generators are, for example, video processing LSIs, CCD clock timing CLK generators, and IC chips that perform processing as A/D conversion LSIs.

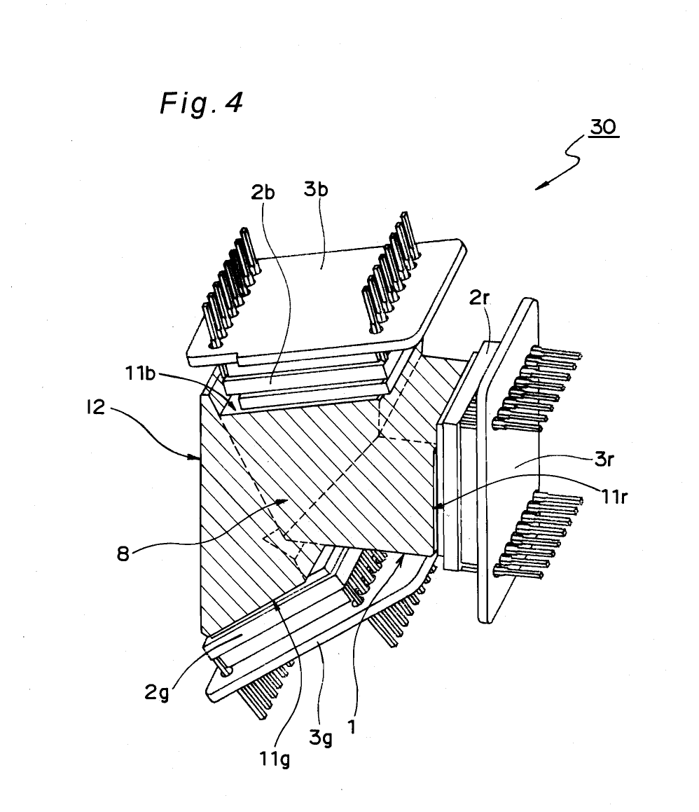

FIG. 4 shows a schematic perspective view of an image pickup block 30 equipped with the heat radiating structure of this embodiment. It is noted that the image pickup block 30 is similar in structure to the image pickup block 10 of FIG. 1, and so like component members are designated by like reference numerals and their description is omitted.

As shown in FIG. 4, the image pickup block 30 is equipped with a light shielding member 8 as the heat radiating structure. The light shielding member 8 is so placed as to cover surfaces of a three color separation prism 1 in which three prism members 1r, 1g, 1b are bonded together. That is, the light shielding member 8 is so placed as to cover surfaces (hereinafter, referred to as side faces) of the three color separation prism 1 except an incidence surface 12 for receiving light that has been incident thereon through an image pickup lens as well as except joint surfaces (or fixing surfaces) 11r, 11g, 11b at which the solid-state image sensors 2r, 2g, 2b and the prism members 1r, 1g, 1b are bonded together (that is, fixed with each other). More specifically, as shown in FIG. 4, the light shielding member 8 is placed over hatched regions in the surfaces of the three color separation prism 1.

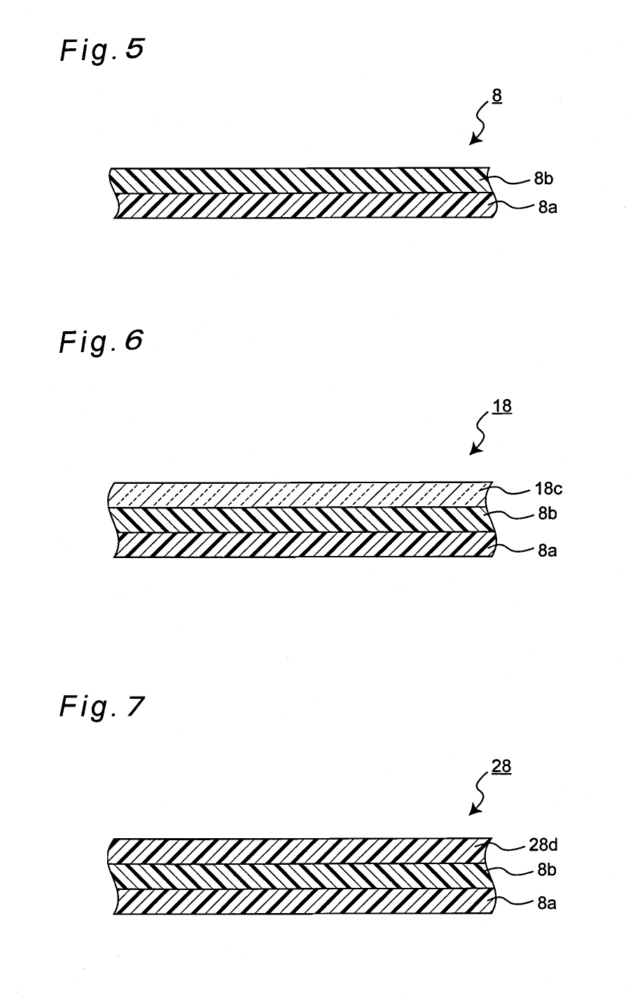

Next, the light shielding member 8 is described with reference to FIG. 5. FIG. 5 shows a schematic sectional view for explaining the structure of the light shielding member 8 of this embodiment. As shown in FIG. 5, the light shielding member 8 is made up of a light shielding layer 8a and a heat radiating layer 8b.

The light shielding layer 8a, which is given by using a matte sheet or the like as an example, serves to shield the prism members from light. The term “light shielding” in this embodiment means to prevent light, which has been incident through the image pickup lens, from going outside from inside the three color separation prism 1 while preventing external light, which comes without passing through the image pickup lens, from being incident inside the three color separation prism 1. Using the light shielding layer 8a like this to shield the prism members from light allows the solid-state image sensors 2r, 2g, 2b to reliably receive only light that has been incident thereon through the image pickup lens.

The heat radiating layer 8b, which is given by using, for example, copper or graphite sheet as a high heat conductivity material, radiates heat.

In the light shielding member 8, the light shielding layer 8a and the heat radiating layer 8b are bonded to each other via, for example, adhesive, so as to be formed into an integral sheet-like member. The light shielding member 8 is bonded to the side faces of the three color separation prism 1 by using, for example, adhesive so that the light shielding layer 8a side is placed on the surface of the three color separation prism 1. The light shielding member 8 is placed so as to extend over the surfaces of the prism members up to proximities of the joint portions with the solid-state image sensors 2r, 2g, 2b while being kept from contact with the solid-state image sensors 2r, 2g, 2b. In this embodiment, the proximities of the joint portions refer to, for example, portions of the side faces of the three color separation prism 1 delimited by their end portions adjoining their corresponding joint surfaces 11r, 11g, 11b, respectively. Accordingly, the state that the light shielding member is placed up to the proximities of the joint portions means that the light shielding member 8 is placed, for example, at least at their end portions adjoining those respective joint surfaces 11r, 11g, 11b. Alternatively, the state may be that in the light shielding member 8, at least its heat r adiating layer 8b is placed further closer to the individual solid-state image sensors 2r, 2g, 2b to such an extent that at least the heat radiating layer 8b does not make contact with those solid-state image sensors 2r, 2g, 2b. That is, the light shielding member 8 may be placed so as to extend around the end portions adjoining the joint surfaces 11r, 11g, 11b in the side faces of the three color separation prism 1 to such an extent that the heat radiating layer 8b does not make contact with the solid-state image sensors 2r, 2g, 2b.

In the image pickup block 30 adopting such a structure as described above, heat generated from the solid-state image sensors 2r, 2g, 2b is transferred through the joint surfaces 11r, 11g, 11b to the three color separation prism 1 and further, via the light shielding layer 8a, to the heat radiating layer 8b. As a result, the heat transferred to the heat radiating layer 8b is released from the surface of the heat radiating layer 8b into the surrounding gas, i.e., atmospheric air. Therefore, since the heat radiating layer 8b, which radiates the heat generated in the individual solid-state image sensors, is placed over a wide range on the surfaces of the three color separation prism 1, a high heat radiating effect can be obtained. Also, the matte sheet forming the light shielding layer 8a is desirably of high heat conductivity. In this case, heat conductivity from the three color separation prism 1 to the heat radiating layer 8b can be enhanced, so that the heat radiating effect for the heat generated in the solid-state image sensors 2r, 2g, 2b can be enhanced. In particular, by the light shielding member 8 being placed up to proximities of the joint portions of the solid-state image sensors 2r, 2g, 2b, heat generated in the solid-state image sensors 2r, 2g, 2b can be transferred to the heat radiating layer 8b more effectively.

Furthermore, in the light shielding member 8 having such a structure as described above, the heat radiating layer 8b is bonded to the side faces of the three color separation prism 1 so as to cover up to proximities to the solid-state image sensors 2r, 2g, 2b and not to make contact with the solid-state image sensors 2r, 2g, 2b as described above. Thus, there is no occurrence of stress loads such as springback from the heat radiating layer 8b to the solid-state image sensors 2r, 2g, 2b.

Accordingly, with the adoption of the light shielding member 8 having such a structure as in this embodiment, heat generated in the solid-state image sensors 2r, 2g, 2b is transferred to the light shielding member 8 so as to be released into its surrounding gas, so that temperatures of the individual solid-state image sensors 2r, 2g, 2b are reduced. Further, the light shielding member 8 having such a structure as shown above is neither brought into contact with nor fixed to the solid-state image sensors 2r, 2g, 2b. Therefore, occurrence of stress loads due to contact or fixation of the light shielding member 8 can be prevented, so that the adhesive with which the solid-state image sensors 2r, 2g, 2b are fixed can be prevented from creeping deformation.

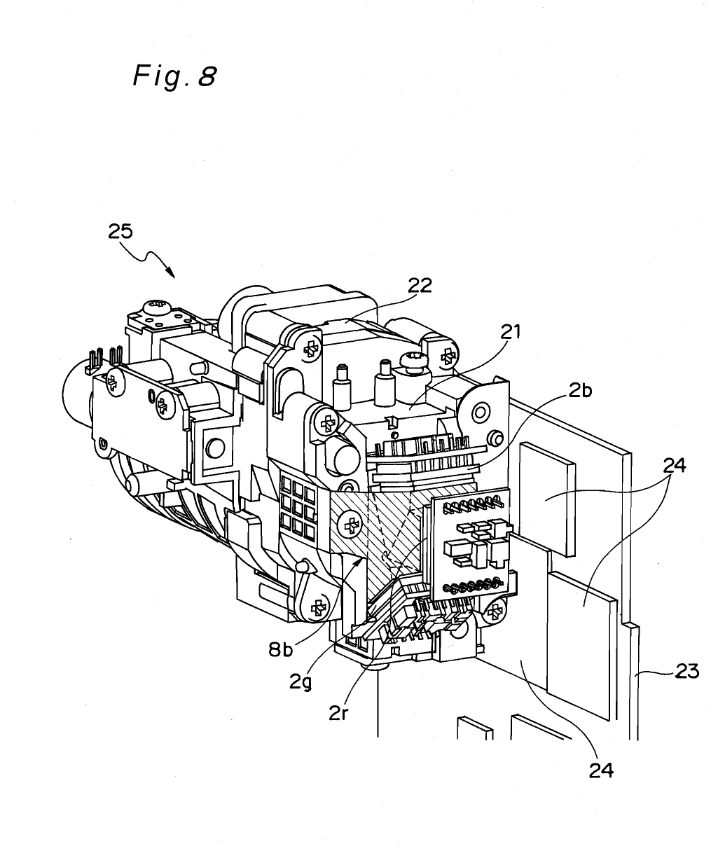

FIG. 8 shows a schematic constructional view of a state in which the above-described image pickup device of FIG. 3 is equipped with the heat radiating structure of this embodiment. As shown in FIG. 8, the heat radiating layer 8b (hatched portion in FIG. 8) may be of a structure that it is fixed to, for example, the lens barrel 22 formed of ABS resin or the body casing (not shown) of the image pickup device by screwing or the like. With such a structure adopted, heat generated in the solid-state image sensors 2r, 2g, 2b is transferred through the heat radiating layer 8b to the lens barrel 22 or the casing or the like, so that temperatures of the individual solid-state image sensors 2r, 2g, 2b are further reduced in addition to the heat radiation from the heat radiating layer 8b. That is, in the light shielding member 8 of this embodiment, the heat radiating layer 8b is not limited to the case where the heat radiating layer 8b has only the function of releasing transferred heat into its surrounding atmospheric air, but may also have a heat transfer function of further transferring the transferred heat to another member so as to let the heat escape, in addition to the foregoing heat radiating function.

Desirably, the light shielding member 8 is formed so as to have high flexibility in its thicknesswise direction. Such a structure, when adopted, makes it possible to improve the workability in the bonding of the light shielding member 8 to surfaces of the three color separation prism 1.

Furthermore, it is also allowable to adopt such a structure, as a modification of this embodiment, in which, for example, a heat shielding layer is further provided in the light shielding member 8. Such a heat shielding layer may be, for example, a heat insulating layer 18c serving for shielding of heat radiation (heat transfer) from the heat-generator IC chips 24 shown in FIG. 3 to their corresponding solid-state image sensors 2r, 2g, 2b. In this connection, FIG. 6 shows a schematic sectional view of the light shielding member 18 including the heat insulating layer 18c which is an example of the heat shielding layer.

As shown in FIG. 6, in the light shielding member 18, the heat insulating layer 18c is placed on a surface of the heat radiating layer 8b. With such a structure, heat radiated from the heat generators is insulated by the heat insulating layer 18c and thus prevented from being transferred through the heat radiating layer 8b and the light shielding layer 8a to the three color separation prism 1. As a result, temperature increases of the solid-state image sensors 2r, 2g, 2b due to radiant heat derived from the heat generators can be suppressed.

Furthermore, in the light shielding member 8, the heat shielding layer may be a reflecting layer 28d which is a reflecting member for reflecting such heat radiation as described above, instead of the heat insulating layer 18c. In this connection, FIG. 7 shows a schematic sectional view of a light shielding member 28 including the reflecting layer 28d which is an example of the heat shielding layer.

As shown in FIG. 7, in the light shielding member 28, the reflecting layer 28d is placed on a surface of the heat radiating layer 8b with the reflecting surface of the reflecting layer 28d directed upward as in the figure. In this case also, heat radiated from the heat generators is reflected by the reflecting layer 28d and thus can be prevented from being transferred through the heat radiating layer 8b and the light shielding layer 8a to the three color separation prism 1. As a result, radiant heat derived from the heat generators can be aggressively reflected, so that temperature increases of the solid-state image sensors 2r, 2g, 2b due to the radiant heat derived from the heat generators as described above can be suppressed.

As shown above, in the image pickup device 25, since the side faces of the three color separation prism 1 are covered by the light shielding member 18 or 28 including the heat shielding layer, i.e., the heat insulating layer 18c or the reflecting layer 28d, radiant heat derived from the IC chips 24, which are heat generators to the heat radiating layer 8b and the three color separation prism 1 and the like, can be intercepted by the heat shielding layer. Accordingly, temperature increases of the solid-state image sensors 2r, 2g, 2b due to radiant heat derived from the heat generators can be suppressed through the heat radiating layer 8b, the three color separation prism 1 and the like.

Deteriorations of registration accuracy, which are the issue of the present invention, matter in such cases where the adhesive placed at joint surfaces 11r, 11g, 11b between the solid-state image sensors 2r, 2g, 2b and the prism members 1r, 1g, 1b, respectively, is continuously loaded with stress under a high temperature environment so as to yield creeping deformation. Providing such a light shielding member 8 as described above makes it possible to suppress temperature increases of the solid-state image sensors 2r, 2g, 2b and thereby prevent the creeping deformation of the adhesive, so that deteriorations of the registration accuracy can be suppressed. In particular, since there has been a tendency in recent years that the amount of heat generation from IC chips or the like increases due to higher performance and higher functions of image pickup devices, it is effective to make up a constitution using such a heat shielding layer as shown above to intercept the radiant heat derived from external heat generators so as to suppress temperature increases of solid-state image sensors. For instance, analyzing factors of temperature increases of the solid-state image sensors yield data showing that self heat generation of solid-state image sensors occupies an effect ratio of 40% while heat reception from external heat generators occupies an effect ratio of 60%. From such an analysis result, it can be said that external heat generators have an effect larger than self heat generation on temperature increases of solid-state image sensors, and therefore that intercepting effects of external heat generators by using a heat shielding layer is effective for temperature decreases of the solid-state image sensors.

Also, it has been described in the foregoing embodiment that the sheet-like light shielding member 8 including the light shielding layer 8a and the heat radiating layer 8b is placed on the side faces of the three color separation prism 1. However, the light shielding layer 8a on the side faces of the three color separation prism 1 and further the heat radiating layer 8b on the surface of the light shielding layer 8a may be formed directly on those surfaces, respectively, by, for example, coating, deposition, welding or the like.

It is to be noted that, by properly combining the arbitrary embodiments of the aforementioned various embodiments, the effects possessed by them can be produced.

The image pickup device according to the present invention has an effect of reducing stress loads applied to the solid-state image sensors through heat radiating members while ensuring necessary heat radiation performance with a relatively simple structure, thus being useful as an image pickup device or the like for television cameras, video cameras and the like including solid-state image sensors.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The entire disclosure of Japanese Patent Application No. 2007-211702 filed on Aug. 15, 2007, including specification, claims, and drawings are incorporated herein by reference in its entirety.

What is claimed is:

1. An image pickup device comprising:
a color separation prism made up of a plurality of prism members, for separating light incident thereon through an image pickup lens into a plurality of color components;
a plurality of solid-state image sensors fixed to the plurality of prism members, respectively;
a light shielding layer placed so as to cover a surface of the color separation prism; and
a heat radiating layer which is formed from a high heat conductivity material placed on a surface of the light shielding layer so as to be kept from contact with each of the solid-state image sensors.

2. The image pickup device as defined in claim 1, wherein in side faces of the prism members adjoining joint surfaces onto each of which the solid-state image sensor is fixed, the heat radiating layer is placed at least at ends of the side faces via the light shielding layer, the ends adjoining to the joint surfaces.

3. The image pickup device as defined in claim 2, wherein the light shielding layer is placed so as to cover surfaces of the color separation prism except an incidence surface for light derived from the image pickup lens and except the joint surfaces of the prism members, and the heat radiating layer is placed so as to cover the light shielding layer.

4. The image pickup device as defined in claim 1, wherein a heat shielding layer for suppressing penetration of heat radiated from outside of the color separation prism into inside thereof is placed on a surface of the heat radiating layer.

5. The image pickup device as defined in claim 4, wherein the heat shielding layer is a heat insulating layer for intercepting the radiated heat.

6. The image pickup device as defined in claim 4, wherein the heat shielding layer is a reflecting layer for reflecting the radiated heat.

7. The image pickup device as defined in claim 1, wherein the heat radiating layer is connected to a body casing of the image pickup device.
